(19) United States
(12) Patent Application Publication
(10) Pub. No.: US 2003/0149984 A1
(43) Pub. Date: Aug. 7, 2003

(54) VCR-style transport for navigating electronic program guide (EPG) and other textual information

(75) Inventors: Martino Annette Jacquelyn, Cold Spring, NY (US); John Zimmerman, Ossining, NY (US)

Correspondence Address: PHILIPS ELECTRONICS NORTH AMERICAN CORP, 580 WHITE PLAINS RD, TARRYTOWN, NY, 10591, US

(73) Assignee: KONINLIJKE PHILIPS ELECTRONICS N.V.

(21) Appl. No.: 10/071,392

(22) Filed: Feb. 6, 2002

(51) Int. Cl. G06F 3/00; H04N 5/445; G06F 13/00; H04N 7/16

(52) U.S. Cl. 725/52; 725/47; 725/136

(57) ABSTRACT

An apparatus for controlling the rate at which electronic program guide (EPG) data is scrolled within a video signal corresponding to an EPG display, includes first circuitry for receiving first and second signals, and second circuitry for incrementing and decrementing the scroll rate of EPG data within an output video signal responsive to the first and second signals, respectively. Methods and corresponding software for operating the apparatus are also described.

### BACKGROUND OF THE INVENTION

The present invention relates generally to systems and corresponding methods for presenting textual information. More specifically, the present invention relates to systems and corresponding methods for presenting textual information at variable speeds controlled by the system user.

Digital television (DTV) technology and analog TV employing the vertical blanking interval (VBI) provide the bandwidth for conveying both the viewed program and a large amount of data, e.g., an electronic program guide (EPG) such as that disclosed in U.S. Pat. No. 5,541,738. It should be mentioned that the '738 patent is incorporated herein by reference for all purposes. Numerous other electronic components including personal computers (PCs), set top boxes (STBs), and digital video recorders (DVRs) also include the capability to generate textual information for presentation of text-based information to the component's user(s). For example, STBs and DVRs provide EPG information regarding upcoming television programs to the user in the form of an on-screen display.

It will be appreciated that the devices that provide the EPG information also provide tools that enable the user to navigate the EPG, which tools are generally limited to:

(1) a step function; and/or

(2) a pull down menu function.

The step function permits the user to step forward in time by a preset interval, e.g., one-half hour or one day; the pull down menu function permits the user to select day, date and/or time from a list or lists that “drop down” whenever the user selects at least one predefined area of the EPG.

It will be noted that neither of these tools permit the user to scroll through the programming guide at a speed selected by the user. Moreover, neither of these tools permits the user to scroll through programming guide information at first and second speeds selected by the user. Certainly, neither of these tools permits the user to scroll through programming guide information at one or more variable speeds selected in real time by the user.

Stated another way, there are a number of ways that the viewer can interact with an EPG display program or function. For example, the EPG program can present the viewer with one of more menus. During program selection (or video cassette recorder (VCR) programming), the viewer is prompted with a menu. Selection of an item in a menu can, as often as not, lead the viewer to another menu. Several menus can appear on the viewers television. It will be appreciated that as EPG data becomes increasingly more complex, navigating these menus can present some problems for ordinary viewers who are not “computer literate.” Moreover, scrolling and tabbing through EPG menu layers can become time consuming if the EPG data is organized into more than a small number of menu layers.

Several different approaches to navigation of EPG data have been developed over the years. U.S. Pat. No. 5,541,738 (discussed above) advocates the use of a remote control with a number of extra keys, which keys facilitate navigation through the EPG data. For example, the remote control device includes page up and page down keys in addition to the conventional control keys; these addition keys permit the user to move up or down by one page, i.e., one screen, every time one of these keys is activated. In contrast, a programmable control device, which employs pull down menus, is discussed immediately below.

Moreover, it will be appreciated that the many of the components listed above advantageously can be operated using a universal remote control device or pad. For example, FIG. 1A illustrates a programmable remote controller 1 which has recently been introduced to the market place and which includes a touch screen 11, which advantageously can be employed to display dedicated virtual controls for a plurality of devices being operated. Typical virtual controls for operating a VCR and a STB, e.g., a cable television control box, are illustrated in FIGS. 1B and 1C. Additional functions and macros, i.e., pre-recorded instruction strings, advantageously can be programmed into the remote control device depicted in FIG. 1A. It will be appreciated that the fast forward and reverse keys are available for controlling the VCR but are unavailable for controlling the set top box.

What is needed is a tool that permits the user to scroll through the programming guide at a speed selected by the user. It would be desirable if such a tool permitted the user to scroll through programming guide information at first and second speeds selected by the user. It would also be advantageous if such a tool permitted the user to scroll through programming guide information at one or more variable speeds selected in real time by the user. Preferably, such a tool could be embodied in either software or minimal hardware elements. It would be highly beneficial if the tool were associated with the component providing the EPG data for display while being usable with any universal remote controller.

### SUMMARY OF THE INVENTION

Based on the above and foregoing, it can be appreciated that there presently exists a need in the art for software and corresponding circuitry for controlling the rate of display of EPG data, i.e., textual data, which overcomes the above-described deficiencies. The present invention was motivated by a desire to overcome the drawbacks and shortcomings of the presently available technology, and thereby fulfill this need in the art.

According to one aspect, the present invention provides an apparatus for controlling the rate at which electronic program guide (EPG) data is scrolled within a video signal corresponding to an EPG display, including first circuitry for receiving first and second signals, and second circuitry for incrementing and decrementing the scroll rate of EPG data within an output video signal responsive to the first and second signals, respectively. If desired, the second circuitry includes a software program instantiated by a processor. Alternatively, the second circuitry includes a counter including first and second input ports receiving the first and second signals, respectively, and an output port for providing a cumulative count value, a video signal generator receiving the cumulative count value which generates a video signal representing the scrolling rate of the EPG data corresponding to the cumulative count value. In the latter case, the counter responds to either the first or second signal when one of the first and second signals is present at the start of a pulse included in a clock signal applied to the counter. In either case, the first circuitry includes an input/output port, wherein the first and second signals are generated by a second apparatus. In another exemplary case, the second circuitry includes a ramp function generator including first and second input ports receiving the first and second signals, respectively, and an output port for providing a cumulative ramp value, a video signal generator receiving the cumulative ramp value which generates a video signal representing the scrolling rate of the EPG data corresponding to the cumulative ramp value. Preferably, the cumulative ramp value generated by the ramp function generator is directly proportional to the cumulative duration of the first and second signals.

According to another aspect, the present invention provides a method for controlling the rate at which electronic program guide (EPG) data is scrolled within a video signal, generated by a video signal generator, corresponding to an EPG display. Preferably, the method includes steps for receiving first and second signals, and incrementing and decrementing the scroll rate of the EPG data within the video signal responsive to the first and second signals, respectively. In an exemplary case, the first and second signals are generated by a first apparatus, while the receiving and incrementing steps are performed by a second apparatus; in that arrangement, the first apparatus and the second apparatuses are operatively coupled to one another. Advantageously, the scroll rate of the EPG data can be continuously variable. Alternatively, the scroll rate of the EPG data varies in N discrete steps, where N is a positive integer greater than 1.

According to yet another aspect, the present invention provides software, stored in a memory associated with a set top box, which set top box includes a video signal generator that generates a video signal displayable as textual data scrolling at a user-selected scroll rate and a processor which instantiates a program corresponding to the software, the software performing functions including determining a user-selectable scroll rate for textual data responsive to first and second control signals, generating a scroll rate control signal, and applying the scroll rate control signal to the video signal generator to thereby generate a video signal including the textual information scrolling at the user-selected scroll rate. If desired, the determining function determines the user-selectable scroll rate responsive to the number of times the first and second signals are generated. Alternatively, the determining function determines the user-selectable scroll rate based on the duration of the first and second control signals. Moreover, the determining function advantageously can determine the user-selectable scroll rate based on the magnitude of a value incremented by the first signal and decremented by the second signal.

According to a still further aspect, the present invention provides an apparatus for controlling the rate at which electronic program guide (EPG) data is scrolled within a video signal corresponding to an EPG display, including an input port that receives at least one of first and second signals, a processor operatively connected to the input port that generates a scroll rate control signal responsive to the received at least one of the first and second signals, a video signal generator that generates a video signal including EPG data scrolling at the scroll rate corresponding to the scroll rate control signal. If desired, the processor can include either a microprocessor or a digital signal processor, or both. Moreover, the processor advantageously may include discrete circuit components. For example, the processor can include a counter receiving the first and second signals and generating a cumulative count value corresponding to the scroll rate control signal. In an exemplary case, the processor includes a microprocessor, and the microprocessor instantiates a counter routine that generates a cumulative count value corresponding to the scroll rate control signal responsive to the first and second signals. Alternatively, the processor can include a ramp function generator including first and second input ports receiving the first and second signals, respectively, and an output port for providing the scroll rate control signal corresponding to a cumulative ramp value. In the latter case, the cumulative ramp value generated by the ramp function generator is directly proportional to the cumulative duration of the first and second signals. In any case, the input port can include a detector, which detects infrared signals, and the first and second signals include first and second infrared signals.

### BRIEF DESCRIPTION OF THE DRAWINGS

These and various other features and aspects of the present invention will be readily understood with reference to the following detailed description taken in conjunction with the accompanying drawings, in which like or similar numbers are used throughout, and in which:

FIG. 1A depicts a programmable universal remote controller that advantageously can be W employed with the methods according to the present invention;

FIGS. 1B and 1C illustrate alternative screen presentations including virtual keys which are generated by universal remote controller illustrated in FIG. 1A;

FIG. 2 illustrates an exemplary embodiment of circuitry suitable for providing controlled scroll rate electronic program guide (EPG) data for display according to the present invention;

FIG. 3 is a high level flowchart illustrating a method for controlling the display rate of EPG data according to the present invention;

FIG. 4 depicts first exemplary circuitry suitable for generating signals suitable for controlling the display rate of EPG data according to the present invention; and

FIG. 5 depicts second exemplary circuitry suitable for generating signals for controlling the display rate of EPG data according to the present invention.

### DETAILED DESCRIPTION OF THE PREFERRED EMBODIMENTS

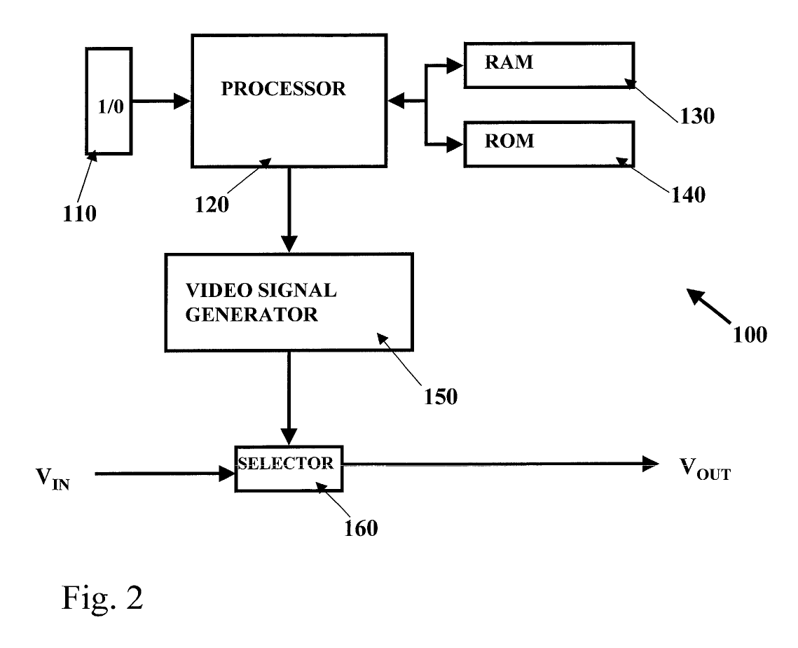

FIG. 2 illustrates an exemplary apparatus 100, which advantageously can be included in the STBs, DVRs, computers, etc., discussed above, and which includes an input/output port 110 electrically coupled to a processor 120. Preferably, the processor 120 is coupled to both a random access memory (RAM) 130 and a read only memory (ROM) 140. The former provides temporary storage for data generated by programs and routines instantiated by the processor 120; the latter stores the programs and permanent data used by these programs. It should be mentioned at this point that the processor 120 advantageously can be one of a microprocessor or a digital signal processor; in an exemplary case, the processor 120 can include both types of processors. It should also be mentioned that the ROM 140 advantageously can be a static RAM (SRAM) or electrically programmable ROM (EPROM or EEPROM), which would permit the programs and “permanent” data to be updated as new program versions become available. In any event, the processor 120 is electrically coupled to a video signal generator 150, which is coupled to a first input of a selector 160. A second input of the selector 160 receives a video signal Vᵢₙ. As illustrated in FIG. 2, the output of the selector 160 is a video signal Vₒᵤₜ.

Preferably, the selector 160 can be one of a single pole switch or a notch filter-adder combination. Other configurations will occur to one of ordinary skill in the art and all such configurations are considered to fall within the scope of the present invention. It will be noted that the selector permits normal video program output to be suppressed in favor of the EPG textual information.

It should be noted that the I/O port 110 advantageously can be any one of a radio frequency detector, an infrared detector, a current detector, or a voltage detector. It will also be noted that the I/O port 110 can be an input device suitable for receiving one of two analog signals or two digital signals. Moreover, the communications channel to which the I/O port 110 is coupled can be either a wired communications channel or a wireless communications channel.

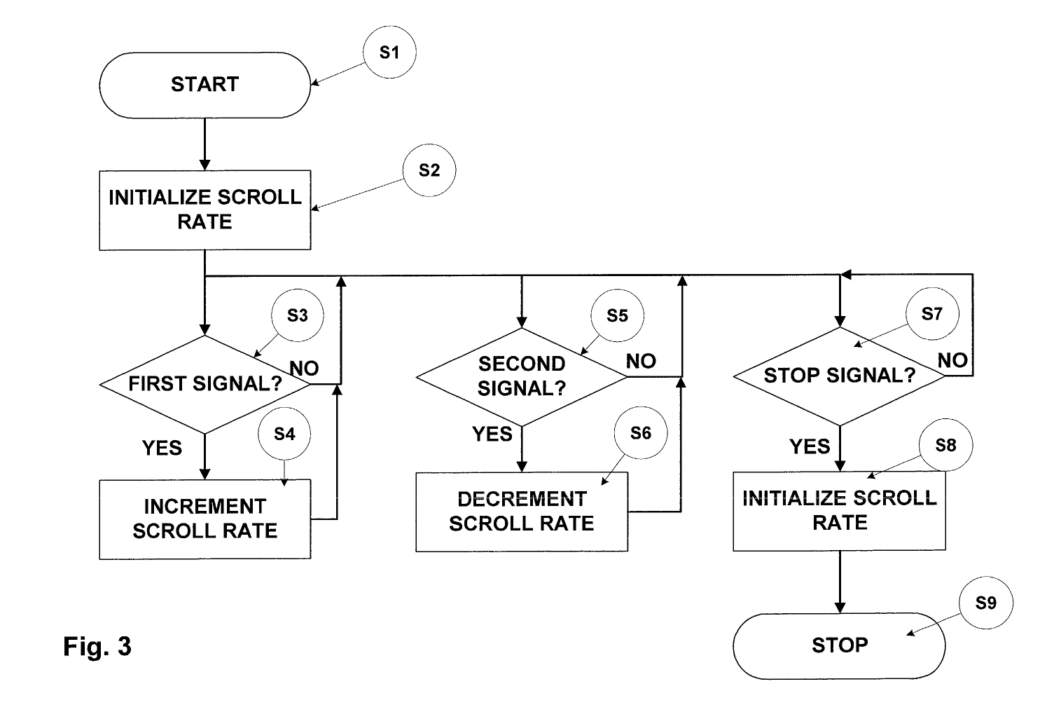

Various aspects of the present invention can be best understood by referring to the flow chart of FIG. 3, which illustrates a routine that can be implemented in software on the processor 120 of FIG. 2 or can be implemented in discrete logic circuitry. In any event, the software routine starts at step S1, where the software is instantiated and initialized. During a subsequent step S2, the scroll rate is initialized to a predetermined value, which can be positive or negative. In an exemplary case, this corresponds to a nominal scroll rate; alternatively, the initial scroll rate advantageously may be set to zero. During steps S3, S5, and S7, which steps may all be performed either in parallel or serially, the processor waits for the application of either a first signal, a second signal, or a stop signal. In the exemplary case under discussion, the first signal corresponds to a incrementing signal and, thus, the scroll rate is incremented by a predetermined value and applied to the video signal generator during step S4. Moreover, the second signal corresponds to a decrementing signal and, thus, the scroll rate is decremented by a predetermined value and applied to the video signal generator during step S6. Since the user may ultimately desire to terminate EPG display scrolling, a step signal, recognized during step S7, causes the scroll rate signal to again be initialized and applied to the video signal generator 150 during step S8. After completion of step S8, the routine ends at step S9. It will be appreciated that if the results of the determination steps S3, S5, and S7 are negative, the routine loops back to the beginning of these steps to await user input.

It should be mentioned in an exemplary case, the first signal corresponds to a fast forward signal generated by a remote control device. In that case, the second signal corresponds to a rewind signal generated by the remote control device. The stop signal would correspond to the stop signal generated by a remote control device. It should also be mentioned that the fast forward, the rewind, and the stop signals are routinely generated by a universal remote control device when a VCR control mode of operation is selected; these signals are either not generated (or simply not employed) in other modes of operation including the EPG display mode. According to one aspect to the present invention, the device including an EPG display function takes full advantage of these normally unused signals to increase the functionality and usability of the EPG display mode of operation.

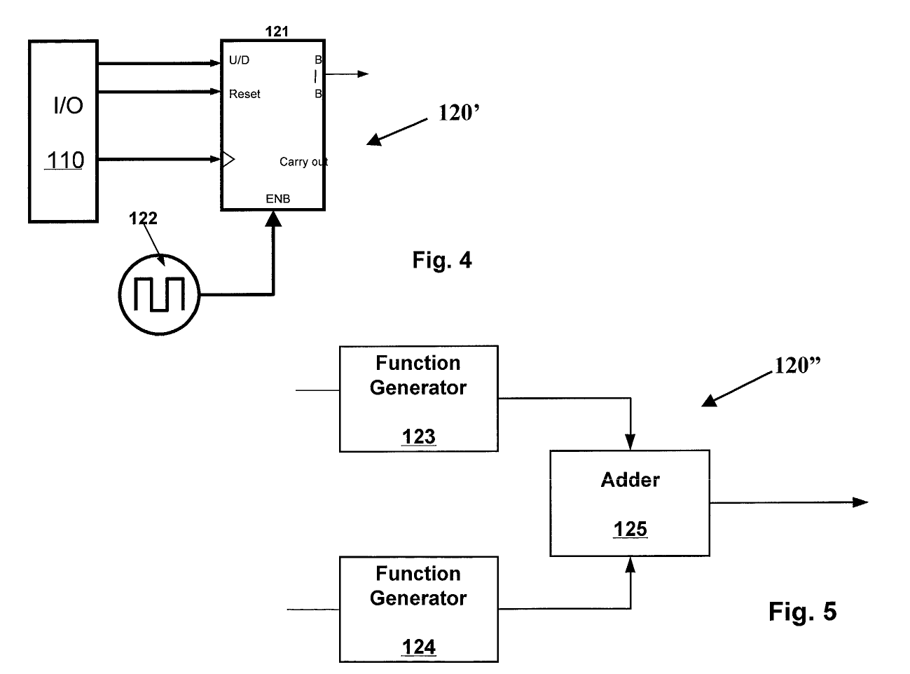

It should be mentioned that the incrementing and decrementing functions discussed with respect to FIG. 3 advantageously may be achieved in either software or hardware. For example, FIGS. 4 and 5 depict alternate functional elements by which the above-mentioned incrementing and decrementing function advantageously can be implemented. It will be appreciated that counter 121 illustrated in FIG. 4 can be a software counter or a hardware counter.

Referring specifically to FIG. 4, the I/O port 110 is operatively connected to a counter 121 enabled by a clock signal generated by a clock 122. In an exemplary case, the I/O port 110 is a infrared detector that receives three distinct pulse trains that the I/O port 110 (or the I/O port 110 in combination with the processor 120) interprets as a first signal, a second signal, and a stop signal. Both the first and second signals are applied to the count terminal of counter 121. It will be appreciated that this can be accomplished through an OR logic element of similar device, assuming that the first signal is of positive potential and the second signal is of negative potential. Other logic arrangements will immediately occur to one of ordinary skill in the art and all such arrangements are considered to be within the scope of the present invention. One or both of the first and second signals advantageously can be applied to the up/down (U/D) port of the counter 121 to control the count direction. The stop signal advantageously can be applied to the Reset port of the counter 121, which zeros the counter output and, ultimately, the scroll rate control signal.

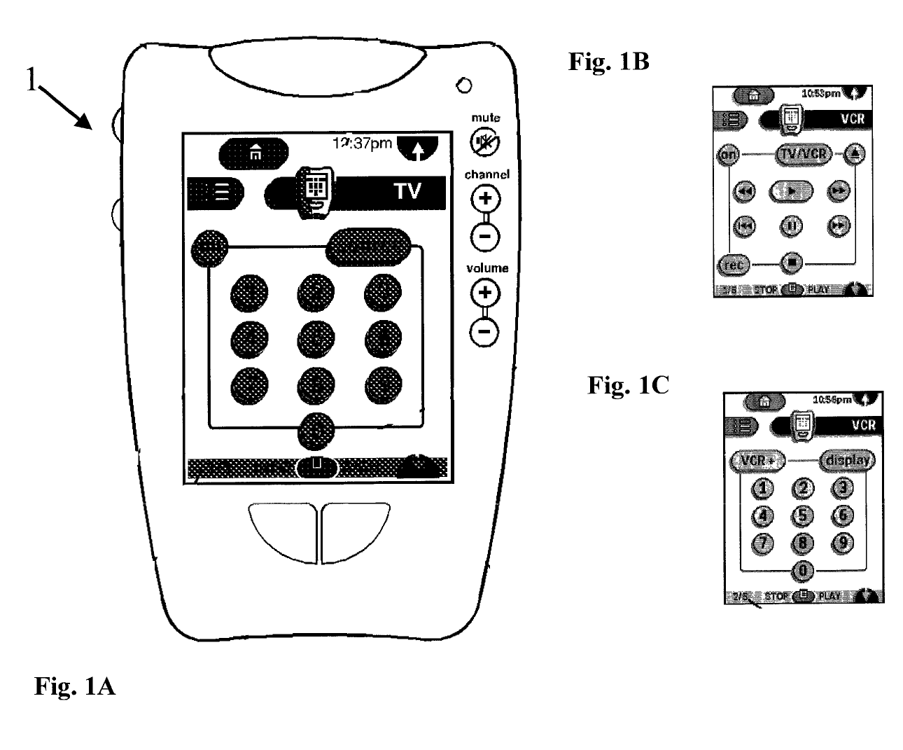

By way of illustration, assume that the fast forward control of the programmable remote controller illustrated in FIG. 1A is pressed five times (or for five seconds) in order to cause the textual data, i.e., the EPG data, to scroll at a rate faster than the video signal generator's predetermined scroll rate. In that case, the first signal in applied to the count terminal of the counter 121 and, whenever the counter is enabled by the clock signal produced by clock 122, the count increments by “1.” The first signal advantageously can be applied to the U/D port or terminal of counter 121 without perceived effect, since the first signal designates that the counter should count up.

Several seconds after the last operation of the fast forward key, the user presses the “rewind” key a number of times (or for a number of seconds). The second signal, which is generated in response to the operation of the rewind key, is applied to both the count terminal and the U/D terminal of the counter 121. Each press of the key is interpreted as a count by virtue of the second signal applied to the counter terminal; however, since application of the second signal to the U/D terminal of the counter 121 causes the count direction to reverse, the counter 121 begins to count down to zero again. It should be noted that the counter may have a predetermined count value stored therein; in that case, the predetermined value corresponds to a no scrolling condition. Thus, the circuit arrangement illustrated in FIG. 4 permits generation of a scroll rate control signal that advantageously can be employed in scrolling in first and second directions, i.e., top to bottom and bottom to top, and not simply between first and second scroll rates in one direction, i.e., two distinct top to bottom speeds.

It should be mentioned that the output of the counter 121 is depicted as a four-bit signal. It will be appreciated that this 4-bit signal can be applied directory when the video signal generator 150 is capable of receiving a digital scroll rate control signal. In the event that an analog signal is required by the video signal generator, the counter 121 advantageously can be coupled to the video signal generator 150 via and digital to analog converter (DAC) (not shown).

Referring to FIG. 5, the circuit arrangement consists of a first function generator 123, which receives the first signal (see discussion above) and a second function generator 124, which receives the second signal. The outputs of the two function generators are identical in form but opposite in sign. For example, function generators 123 and 124 advantageously can each be an integrator, the output of which increases as long as a signal, e.g., either the first or the second signal, is applied to an input or control terminal. The outputs of the two function generators 123 and 124 are combined in adder 125 to generate the scroll rate control signal.

It will be appreciated that the scroll rate control signal generated in FIG. 5 is substantially infinitely variable while the scroll rate control signal generated by the arrangement of FIG. 4 produces scroll rate control signals that are step-wise variable. It will also be appreciated that the scroll rate control signal generated in FIG. 5 is generated based on the duration of the first and second signals. In contrast, the scroll rate control signal generated by the arrangement of FIG. 4 is produced primarily as a function of the number of times the various keys are operated.

It will also be noted that other arrangements are possible. For example, the function generators illustrated in FIG. 5 advantageously can be replaced by unidirectional counters while the adder can be replaced by a look up table (LUT), whose output is determined by the outputs of both the first and second counters. Moreover, pressure sensors and the like advantageously can be employed to generate first and second signals directly proportional to the pressure applied by the user to first and second operating elements, e.g., keys, buttons, dials. An example of the latter is a spring-loaded dial furnished on several brands of VCR remote controllers. More specifically, the shuttle and jog control device disclosed in U.S. Pat. No. 5,187,630 to MacKay et al., which is incorporated herein by reference, advantageously can be employed in the scroll rate control apparatus according to the present invention.

It will be appreciated that the present invention is not simply directed to STBs and DVRs; the present invention, and particularly the corresponding method, can be incorporated into a computer equipped with a joy stick control device, since such devices generate first and second signals of variable magnitude suitable for use as the first and second control signals. It will be appreciated that this would permit the user to scroll through text documents displayed, in an exemplary case, by way of graphical user interface (GUI).

It should be mentioned at this point that the methods and/or circuitry are not merely applicable to vertical scrolling of the EPG, since many EPGs must be scrolled both horizontally and vertically in order to fully review the EPG data. In that case, two additional controls advantageously can be employed to generate third and fourth signals, which signals can be translated by the processor 120 to form a horizontal scroll rate control signal. In other words, first through control signals advantageously can be generated to form horizontal and vertical scroll rate control signals.

Although presently preferred embodiments of the present invention have been described in detail herein, it should be clearly understood that many variations and/or modifications of the basic inventive concepts herein taught, which may appear to those skilled in the pertinent art, will still fall within the spirit and scope of the present invention, as defined in the appended claims.

What is claimed is:

1. An apparatus for controlling the rate at which electronic program guide (EPG) data is scrolled within a video signal corresponding to an EPG display, comprising:
first means for receiving first and second signals; and
second means for incrementing and decrementing the scroll rate of EPG data within an output video signal responsive to the first and second signals, respectively.

2. The apparatus as recited in claim 1, wherein the second means comprises a software program instantiated by a processor.

3. The apparatus as recited in claim 1, wherein:
the first means comprises an input/output port; and
the first and second signals are generated by a second apparatus.

4. The apparatus as recited in claim 1, wherein the second means comprises:
a counter including first and second input ports receiving the first and second signals, respectively, and an output port for providing a cumulative count value; and
a video signal generator receiving the cumulative count value which generates a video signal representing the scrolling rate of the EPG data corresponding to the cumulative count value.

5. The apparatus as recited in claim 4, wherein the counter responds to either the first or second signal when one of the first and second signals is present at the start of a pulse included in a clock signal applied to the counter.

6. The apparatus as recited in claim 1, wherein the second means comprises:
a ramp function generator including first and second input ports receiving the first and second signals, respectively, and an output port for providing a cumulative ramp value; and
a video signal generator receiving the cumulative ramp value which generates a video signal representing the scrolling rate of the EPG data corresponding to the cumulative ramp value.

7. The apparatus as recited in claim 1, wherein the cumulative ramp value generated by the ramp function generator is directly proportional to the cumulative duration of the first and second signals.

8. A method for controlling the rate at which electronic program guide (EPG) data is scrolled within a video signal, generated by a video signal generator, corresponding to an EPG display, comprising:
receiving first and second signals; and
incrementing and decrementing the scroll rate of the EPG data within the video signal responsive to the first and second signals, respectively.

9. The method as recited in claim 8, wherein:
the first and second signals are generated by a first apparatus;
the receiving and incrementing steps are performed by a second apparatus; and
the first apparatus and the second apparatus are operatively coupled to one another.

10. The method as recited in claim 8, wherein the scroll rate of the EPG data is continuously variable.

11. The method as recited in claim 8, wherein the scroll rate of the EPG data varies in N discrete steps, where N is a positive integer greater than 1.

12. Software, stored in a memory of a set top box, which set top box includes a video signal generator that generates a video signal displayable as textual data scrolling at a user-selected scroll rate and a processor which instantiates a program corresponding to the software, the software performing functions including:
determining a user-selectable scroll rate for textual data responsive to first and second control signals;
generating a scroll rate control signal; and
applying the scroll rate control signal to the video signal generator to thereby generate a video signal including the textual information scrolling at the user-selected scroll rate.

14. The software as recited in claim 13, wherein the determining function determines the user-selectable scroll rate responsive to the number of times the first and second signals are generated.

15. The software as recited in claim 13, wherein the determining function determines the user-selectable scroll rate based on the duration of the first and second control signals.

16. The software as recited in claim 13, wherein the determining function determines the user-selectable scroll rate based on the magnitude of a value incremented by the first signal and decremented by the second signal.

17. An apparatus for controlling the rate at which textual data is scrolled within a video signal corresponding to an on-screen display, comprising:
an input port that receives at least one of first and second signals;
a processor operatively connected to the input port that generates a scroll rate control signal responsive to the received at least one of the first and second signals; and
a video signal generator that generates a video signal including textual data scrolling at the scroll rate corresponding to the scroll rate control signal.

18. The apparatus as recited in claim 17, wherein the processor comprises a microprocessor.

19. The apparatus as recited in claim 17, wherein the processor comprises a digital signal processor.

20. The apparatus as recited in claim 17, wherein:
the input port comprises a detector which detects infrared signals; and
the first and second signals comprise first and second infrared signals.

21. The apparatus as recited in claim 17, wherein the processor comprises:
a counter receiving the first and second signals and generating a cumulative count value corresponding to the scroll rate control signal.

22. The apparatus as recited in claim 17, wherein:
the processor comprises a microprocessor; and
the microprocessor instantiates a counter routine that generates a cumulative count value corresponding to the scroll rate control signal responsive to the first and second signals.

23. The apparatus as recited in claim 17, wherein the processor comprises:
a ramp function generator including first and second input ports receiving the first and second signals, respectively, and an output port for providing the scroll rate control signal corresponding to a cumulative ramp value.

24. The apparatus as recited in claim 23, wherein the cumulative ramp value generated by the ramp function generator is directly proportional to the cumulative duration of the first and second signals.

25. The apparatus as recited in claim 17, wherein the textual data comprises electronic program guide (EPG) data.

26. The apparatus as recited in claim 17, wherein the on-screen display comprises a graphical user interface (GUI).
